(19) United States
(12) Patent Application Publication
(10) Pub. No.: US 2017/0241449 A1
(43) Pub. Date: Aug. 24, 2017

(54) Jet Pipe Arrangement For A Servo Valve

(71) Applicant: Hamilton Sundstrand Corporation, Charlotte, NC (US)

(72) Inventor: Lukasz WIKTORKO, Wroclaw (PL)

(21) Appl. No.: 15/363,704

(22) Filed: Nov. 29, 2016

(30) Foreign Application Priority Data
Feb. 19, 2016 (EP) 16156561.9

(51) Int. Cl. F15B 13/04; F15B 13/044

(52) U.S. Cl. CPC F15B 13/0402; F15B 13/044; F15B 2013/0448

(57) ABSTRACT

A jet pipe arrangement for a servo valve, the jet pipe arrangement including a jet pipe, at least two receivers in operable communication with the jet pipe. The jet pip arrangement further includes an electromagnet in direct magnetic communication with the jet pipe such that, in use, the jet pipe is movable in response to changes in a magnetic field created by the electromagnet to distribute flow from the jet pipe asymmetrically between the at least two receivers.

### FOREIGN PRIORITY

This application claims priority to European Patent Application No. 16156561.9 filed Feb. 19, 2016, the entire contents of which is incorporated herein by reference.

### TECHNICAL FIELD

This disclosure relates generally to a hydraulic servo valve. In particular, the disclosure relates to an electromagnetic jet pipe arrangement within a hydraulic servo valve.

### BACKGROUND OF THE INVENTION

Servo valves are generally used when accurate position control is required, such as, for example, control of a primary flight surface. Servo valves can be used to control hydraulic actuators or hydraulic motors. They are common in industries which include, but are not limited to, automotive systems, aircraft and the space industry.

A known type of hydraulic servo valve is a flapper or jet pipe arrangement. In this arrangement, the primary components in the servo valve are the torque motor, flapper nozzle or jet pipe and one or more servos.

### SUMMARY OF THE INVENTION

In one example, there is provided a jet pipe arrangement for a servo valve, the jet pipe arrangement including a jet pipe, at least two receivers in operable communication with the jet pipe. The jet pip arrangement further includes an electromagnet in direct magnetic communication with the jet pipe such that, in use, the jet pipe is movable in response to changes in a magnetic field created by the electromagnet to distribute flow from the jet pipe asymmetrically between the at least two receivers.

In another example, there is provided a servo valve. The servo valve includes the jet pipe arrangement discussed above and a spool located between a first chamber and a second chamber, wherein the spool is movable between the first chamber and the second chamber. The servo valve further includes a supply pressure inlet and a flexible tube connected to the supply pressure inlet and the first end of the jet pipe. The one or more receivers are fluidly connected to the first and second chambers, such that, in use, when the torque motor is activated, the spool can move position between the first and second chambers.

### BRIEF DESCRIPTION OF THE DRAWINGS

FIG. 1 shows a known arrangement of a servo valve; and

FIG. 2 shows an example of a new type of servo valve.

### DETAILED DESCRIPTION

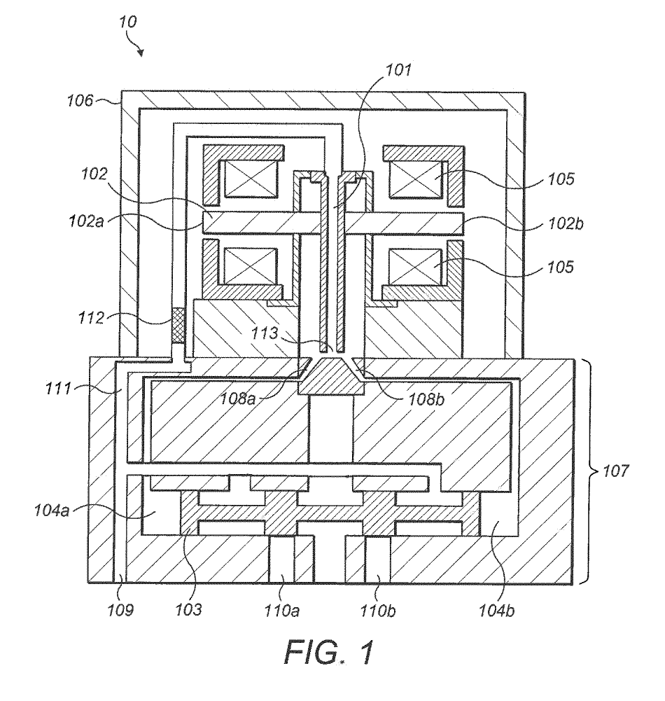

FIG. 1 shows generally a known arrangement of a hydraulic servo valve 10. The hydraulic servo valve 10 shown in FIG. 1 represents a jet pipe type arrangement as discussed above. The primary components of the jet pipe type arrangement are the jet tube 101 for receiving a supply pressure, an armature 102 connected to the jet pipe 101, and an electromagnet 105 surrounding the armature 102. In known arrangements, the jet pipe 101 and the armature 102 are separate components. An electrical input (not shown) is connected to the electromagnet 105. When an electrical current is supplied to the electromagnet 105, the armature 102 changes position due to electromagnetic forces supplied by the electromagnet 105. The jet pipe arrangement shown in FIG. 1 may be contained within a housing 106.

In the example shown, the armature 102 is connected in a perpendicular manner to the jet pipe 101, or is an integral part of the jet pipe 101—the integral part being perpendicular to the jet pipe 101. The electromagnet 105 provides a torque that is proportional to the electrical current that is provided by the electrical input. The armature 102 may include coils (not shown) and the electromagnet 105 consists of a set of permanent magnets (not shown) surrounding the armature 102. When a current is applied to the armature 102, magnetic flux acting on the ends of the armature 102 is developed. The direction of the magnetic flux (force) depends on the sign (direction) of the current. The magnetic flux will cause the armature tips (102a, 102b) to be attracted to the electromagnet 105 (current direction determines which magnetic pole is attracting and which one is repelling). This magnetic force creates an applied torque on the jet pipe 101, which is proportional to applied current. The jet pipe 101 rotates and interacts with a spool portion (shown generally as 107 in FIG. 1).

The primary components of the spool portion 107 are receivers 108a and 108b that are in fluid communication with chambers 104a and 104b. There is also provided a spool 103 which is movable between chambers 104a and 104b. The movement of the spool 103 is accurately controlled by the jet pipe 101 and the pressure provided in chambers 104a and 104b.

The hydraulic servo valve 10 also includes a supply pressure inlet flexible tube 111 connected to a supply pressure inlet 109 that provides fluid into the flexible tube 111. The fluid passes through a filter 112 and then through jet pipe 101. At the end of the jet pipe 101 is a nozzle 113.

In use, the jet pipe 101 converts kinetic energy of moving fluid into static pressure. When the jet pipe 101 is centred between the receivers 108a and 108b, the pressure on the spool 103 is equal. However, when the jet pipe 101 is rotated by the armature 102 and electromagnet 105 toward one of the receivers—say 108a, the pressure at this receiver 108a is greater than the other receiver 108b. This creates a load of imbalance on the servo 103 causing the spool 103 to move. If, for example, the jet pipe 101 is rotated toward the receiver 108a, this could cause the spool 103 to move to the right and into chamber 104b, as the pressure would be greater in chamber 104a, and the pressure would be decreased in chamber 104b. As the spool 103 moves from a null position—i.e., when the pressure is equal in chambers 104a and 104b —outlets 110a and 110b can control pressure in an actuator (not shown). The actuator part of the servoactuator has the same characteristics as any known hydraulic actuator.

Whilst the type of arrangement shown in FIG. 1 controls the position of the jet pipe 101 and the spool 103, this arrangement is costly and complex due to the amount of components necessary for the servo valve 10. What is needed therefore is a new type of servo valve that reduces the weight and size of known arrangements of servo valves, and to simplify the structure in order to reduce costs and complexity of the device.

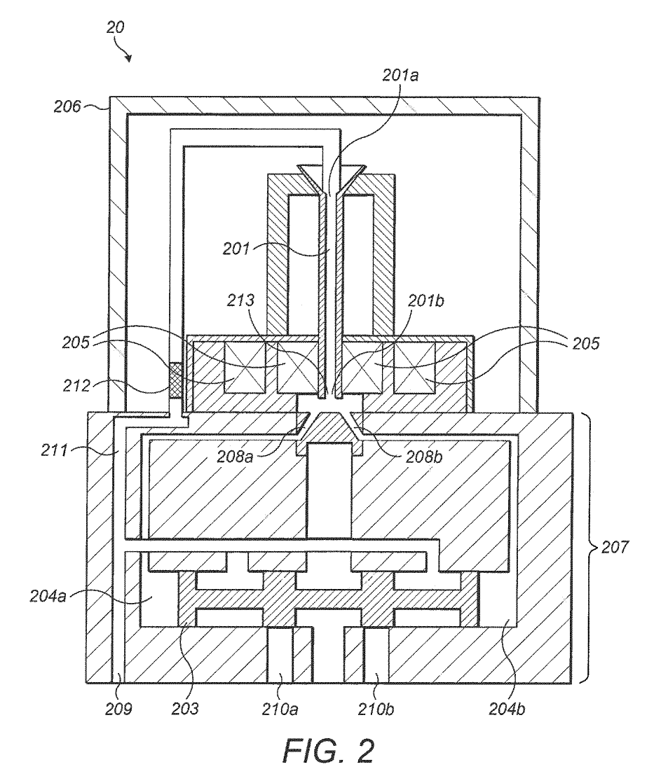

FIG. 2 shows a new type of hydraulic servo valve 20. Here, the jet type arrangement includes a jet pipe 201 for receiving a supply pressure, and an electromagnet 205. The jet pipe arrangement shown in FIG. 2 may be contained within a housing 206. The jet pipe 201 may have a first end 201a and a second end 201b. The electromagnet 205 is arranged to surround the jet pipe 201. In the example shown in FIG. 2, the electromagnet 205 surrounds the second end 201b. However, it is to be understood that the electromagnet 205 may surround the first end 201a or any portion of the jet pipe 201 extending between the first end 201a and the second end 201b. The jet pipe 201, of FIG. 2, has no armature. Therefore, the electromagnet 205 interacts with the jet pipe 201 only. The jet pipe 201 of FIG. 2 may include a coating (not shown) with magnetic properties that interact with the electromagnet 205. In one example, the coating of the jet pipe may be iron oxide nanoparticles. In another example, the jet pipe 201 of FIG. 2 may include neodymium magnets (not shown) on an outer surface of the jet pipe 201 that interact with the electromagnet 205. In a further example, the jet pipe 201 may include windings around the outer surface of the jet pipe 201 to interact with the electromagnet 205.

An electrical input (not shown) is applied to the electromagnet 205. When an electrical current is supplied to the electromagnet 205, the jet pipe 201 changes position due to electromagnetic forces supplied by the electromagnet 205. The rotation of the jet pipe 201 is controlled by the electromagnetic forces supplied by the electromagnet 205. In the example shown in FIG. 2, there is no armature—therefore, the electromagnet 205 directly causes the jet pipe 201 to rotate. Advantageously, this reduces the overall weight of a servo valve and reduces the number of parts in the servo valve, which reduces the overall complexity and cost of the servo valve.

The electromagnet 205 provides a torque that is proportional to the electrical current that is provided by the electrical input. The jet pipe 201 may include a coating or windings, as discussed above, and the electromagnet 205 may consist of a set of permanent magnets surrounding the jet pipe 201. When a current is applied to the jet pipe 201, magnetic flux acting on the jet pipe 201 is developed. The direction of the magnetic flux (force) depends on the sign (direction) of the current. The magnetic flux will cause the jet pipe 201 to be attracted to the torque motor 205 (current direction determines which magnetic pole is attracting and which one is repelling). This magnetic force creates an applied torque on the jet pipe 201, which is proportional to applied current. The jet pipe 201 rotates and interacts with a spool portion (shown generally as 207 in FIG. 2).

The spool portion 207 may include receivers 208a and 208b that are in fluid communication with chambers 204a and 204b. There is also provided a spool 203 which is movable between chambers 204a and 204b. The movement of the spool 203 is accurately controlled by the jet pipe 201 and the pressure provided in chambers 204a and 204b.

The hydraulic servo valve 20 may also include a supply pressure inlet flexible tube 211 connected to a supply pressure inlet 209 that may provide fluid into the flexible tube 211. The fluid may pass through a filter 212 and then through jet pipe 201. At the end of the jet pipe 201 may be a nozzle 213.

In use, the jet pipe 201 converts kinetic energy of moving fluid into static pressure. When the jet pipe 201 is positioned relative to the receivers 208a and 208b such that fluid flow through the jet pipe 201 is evenly divided between the receivers 208a and 208b, the pressure in the chambers 204a and 204b on opposing sides of the spool 203 is equal. However, when at least a portion of the jet pipe 201, such as second end 201b, for example, of the whole of the jet pipe 201 is moved by the electromagnet 205 such that fluid flow through the jet pipe 201 is unevenly distributed between the receivers 208a and 208b, the pressure in the receiver that receives the greater flow causes a load of imbalance on the spool 203 by providing greater pressure to the chamber 204a or 204b that is fluidically connected to the receiver 208a, 208b receiving the greater flow. This pressure difference causes the spool 203 to move. If, for example, the jet pipe 201 is rotated toward the receiver 208a, this could cause the spool 203 to move to the right and into chamber 204b, as the pressure would be greater in chamber 204a, and the pressure would be decreased in chamber 204b. As the spool 203 moves from a null position—i.e., when the pressure is equal in chambers 204a and 204b—outlets 210a and 210b can control pressure in an actuator (not shown). The actuator part of the servoactuator has the same characteristics as any known hydraulic actuator.

Although this disclosure has been described in terms of preferred examples, it should be understood that these examples are illustrative only and that the claims are not limited to those examples. Those skilled in the art will be able to make modifications and alternatives in view of the disclosure which are contemplated as falling within the scope of the appended claims.

1. A jet pipe arrangement for a servo valve, said jet pipe arrangement comprising:
a jet pipe;
at least two receivers in operable communication with the jet pipe; and
an electromagnet in direct magnetic communication with the jet pipe such that, in use, the jet pipe is movable in response to changes in a magnetic field created by the electromagnet to distribute flow from the jet pipe asymmetrically between the at least two receivers.

2. The jet pipe arrangement of claim 1, wherein the jet pipe arrangement has no armature.

3. The jet pipe arrangement of claim 1, wherein the electromagnet is in direct magnetic communication with a first end of the jet pipe.

4. The jet pipe arrangement of claim 1, wherein the electromagnet is in direct magnetic communication with a second end of the jet pipe.

5. The jet pipe arrangement of claim 1, wherein the electromagnet is in direct communication with a section between a first end and a second end of the jet pipe.

6. The jet pipe arrangement of claim 1, wherein the jet pipe has a coating on its outer surface, wherein the coating has magnetic properties.

7. The jet pipe arrangement of claim 6, wherein the coating is iron oxide nanoparticles.

8. The jet pipe arrangement of claim 1, wherein the jet pipe includes neodymium magnets positioned on its outer surface.

9. A servo valve, said servo valve comprising:
the jet pipe arrangement of any preceding claim;
a spool located between a first chamber and a second chamber, wherein the spool is movable between the first chamber and the second chamber;
a supply pressure inlet;
a flexible tube connected to the supply pressure inlet and the first end of the jet pipe; and
wherein the one or more receivers are fluidly connected to the first and second chambers, such that, in use, when the torque motor is activated, the spool can move position between the first and second chambers.

10. The servo valve of claim 9, wherein the servo valve further comprises:
one or more outlets to withdraw fluid from the servo valve.
